(19) United States
(12) Patent Application Publication
(10) Pub. No.: US 2004/0104494 A1
(43) Pub. Date: Jun. 3, 2004

(54) Toric lens manufacture

(76) Inventors: Barrie Bevis, Southampton (GB); Michael James Kelly, Southampton (GB); Robert Hounsell, Southampton (GB); Stephen Saunders, Dorset (GB); Richard Stephen Penny, Hampshire (GB); Peter Frederick Brierley, San Clemente, CA (US)

Correspondence Address: SUGHRUE MION, PLLC, 2100 PENNSYLVANIA AVENUE, N.W., SUITE 800, WASHINGTON, DC, 20037, US

(21) Appl. No.: 10/182,202

(22) PCT Filed: Jan. 15, 2001
(86) PCT No.: PCT/GB01/00153

(30) Foreign Application Priority Data
Jan. 28, 2000 (GB) 0002091.7

(51) Int. Cl. B29D 11/00

(52) U.S. Cl. 264/2.5; 425/808

(57) ABSTRACT

A method of cast moulding toric contact lenses is provided in which each lens has a ballast and a toric central zone having a cylindrical axis, the cylindrical axis having an axis of orientation at a desired rotational angle with respect to the axis of the ballast, said method comprising the steps of: (a) providing male and female mould halves wherein the surface of one mould half defines said cylindrical axis and the other defines said ballast axis; (b) loosely assembling the mould halves and transporting the loosely assembled moulds to a filling station under conditions in which the mould halves are free to move relatively to each other in a rotational sense and are subjected to a joggling action during said transport or while being held prior to entry into the filling station; (c) lifting the male mould halves at the filling station, introducing a flowable polymerisable composition into the female mould halves and closing the male mould fully into the female mould halves and curing the polymerisable composition to form toric contact lenses; and (d) sorting the lenses into groups of lenses having the same or similar rotational angle.

This invention relates to toric lens manufacture and, in particular, is concerned with a method of cast moulding toric contact lenses.

Toric lens are used to correct astigmatism. This is done by shaping the lens so as to provide a cylindrical correction to compensate for the astigmatism. In spectacle lenses, the lens is mounted in the frame in such a way that the cylindrical correction is in the correct orientation with respect to the wearer's eye. In contact lenses, the lens is positioned in the correct orientation on the cornea by providing a ballast which orientates the lens in the correct position when it is inserted onto the cornea. Various ballasting techniques are known to those versed in the art. These include techniques such as prism ballasting, dynamic ballasting and truncation. More recently, modern contact lens lathes have been programmed to produce non-rotationally symmetric surfaces and these can produce bumps on the surface which can be used to orientate the lens. For the purposes of this invention all such arrangements and devices are included in the term “ballast”.

Toric contact lenses are manufactured with a selected rotational relationship between the cylindrical axis of the toric optical zone and the orientation of the ballast. This is often expressed as the number of degrees that the cylindrical axis is offset from the horizontal meridian and this is conventionally termed the “lens axis”. The axis prescription is defined as the angle from the horizontal meridian to the cylindrical axis (in an anti-clockwise direction) and will be a positive number from 0° to 180°.

Toric contact lenses are manufactured by a number of techniques, including machining a lens blank or cast moulding. In cast moulding, one of the mould halves may be designed to mould the cylindrical correction and the other the ballast, although both the cylinder and the ballast may be moulded by the same mould half. For example, the lenticular surface of the female mould half may be shaped to form the ballast and the corresponding surface of the male mould half shaped to mould the cylindrical axis.

Because astigmatism is frequently associated with other visual abnormalities, such as myopia or hypometropia, cast moulding of toric lenses potentially requires a very large number of moulding tools in order to cover the range of rotational angles between the horizontal meridian and the cylindrical axis of 0 to 180°. Even if lenses are moulded with rotational angles at 10° intervals, the combination of different lens powers with the required cylindrical correction, multiplies the number of tools required substantially.

The present invention is directed to a solution to the above problem, and makes use of the same pair of moulding tools for manufacturing plastic moulds, which can then be used to cast mould lenses of the same power over the entire range of lens axes.

WO 99/15327 describes a method of manufacturing toric lenses using a pair of casting moulds, one of which is intended for moulding the front curve and the other for moulding the base curve. A curable monomer is introduced into the front curve moulding half at a filling station and the base curve moulding half is assembled into the base curve half at the correct orientation with respect to the other mould half. Provided the two mould halves are correctly assembled, the resulting moulded lens has the desired combination of power and cylinder. The success of such a method, however, depends on precise control of the orientation of the mould halves prior to and during the assembly step.

The present invention provides a procedure for moulding toric lenses which does not require precise control of the orientation of the mould halves but nevertheless enables the same pair of master moulds to be used to produce a range of toric lenses having different lens axes.

According to the present invention and as is known from WO 99/15327 there is provided a method of cast moulding toric contact lenses in which each lens has a ballast and a toric central zone having a cylindrical axis, the cylindrical axis having an orientation at a desired rotational angle with respect to the axis of the ballast, said method comprising the steps of:

providing sets of male and female mould halves wherein the surface of one mould half of each set defines said cylindrical axis and the surface of the other mould half of each set defines said ballast axis, introducing a flowable polymerisable composition into the female mould halves and closing the associated male mould halves fully into the female mould halves and curing the polymerisable composition to form toric contact lenses. In contrast to WO 99/15327 however the invention comprises the steps of:

loosely assembling the sets of mould halves each in a relative position corresponding to the rotational angle of the majority of lenses to be moulded

transporting the loosely assembled sets of mould halves to a filling station where the flowable polymerisable composition is introduced to the female mould halves, under conditions in which the mould halves of each set are free to move relatively to each other in a rotational sense and the sets are subjected to a deliberate joggling action to ensure the mould halves of the sets assume relative orientations approximately corresponding to a guassion distribution curve during said transport or while being held prior to entry into the filling station and

sorting the lenses into groups of lenses having the same or similar rotational angles.

Freedom to move in a rotational sense refers to rotational movement of the mould halves approximately around their optical axis.

It will be appreciated that although the “rotational angle” as defined above is not the same as the lens axis, it has a fixed relationship with it.

The invention also provides apparatus for cast moulding toric contact lenses and comprising:

machines for moulding respective sets of male and female halves wherein the surface of one mould half of each set defines the cylindrical axis of the subsequently cast lens and the surface of the other mould half defines the ballast axis of the subsequent cast lens

a filling station equipped to introduce a flowable polymerisable composition into the female mould halves and to close the associated male mould halves fully into the female mould halves and

a curing station for curing the polymerisable composition to form toric contact lenses. The apparatus is characterized by a station which is provided to pre-assemble the sets of mould halves loosely together each in a relative position corresponding to the rotational angle of the majority of lenses to be moulded

a transport system composed of pallets and a flexible conveyor for transporting the loosely assembled sets of mould halves from the assembly station to the filling station the transport system serving to ensure the mould halves of each set are made to move relative to one another in a rotational sense and the sets are deliberately joggled to ensure the mould halves of the sets assume relative orientations approximately to a gaussion distribution curve during their transport from the assembly station to the filling station and means is provided for sorting the resulting lenses into groups having the same or similar rotational angles of the cylindrical axis with respect to the horizontal meridian.

The invention capitalises on the fact that if a pair of loosely assembled mould halves are subjected to joggling or agitation for a sufficient period, e.g. 10 to 15 minutes, they will assume a relative orientation to each other which corresponds approximately to a gaussion distribution curve if the mould halves are loosely assembled at the same rotational angle. The maximum of the distribution curve will be the initial rotational angle.

Moreover, if the mould halves are loosely assembled initially at the desired rotational angle of the majority of the lenses required, by the time they enter a lens filling station, they will have assumed a relationship which approximates very closely to the spread of rotational angles required for a typical inventory. This procedure results in a larger through put of lenses than if an attempt is made to bring the two mould halves together at a selected rotational angle at the filling station, because of the additional time involved in orientating the mould halves at this point.

The time required to achieve the desired distribution of rotational angles depends on the conveying design and the arrangements for holding the mould halves in a waiting zone prior to entry into the filling station.

In accordance with a preferred arrangement, the loosely assembled mould halves are conveyed in groups on wheeled pallets which are supported on a flexible link conveyor. The flexible link conveyor comprises an endless chain of flat plastic links which are mutually connected so that the links provide a substantially flat moving support surface for the pallets. One suitable commercial flexible link conveyor is manufactured by Flexlink (www.flexlink.co.uk). The flexible link conveyor is guided on a stationary supporting structure.

As the pallets are conveyed towards the filling station they are jostled around curves and junctions which causes the loosely assembled mould halves to be subjected to random agitation The loosely assembled mould halves are normally held in a waiting zone prior to entry into the filling station. This may conveniently be achieved by providing movable stops which retain the pallet in a holding position while the flexible links of the conveyor continue to run under the pallets. Holding the pallets under such conditions causes further joggling to the mould halves so that by the time the mould halves enter the filling station, the mould halves in a batch of sufficient size loosely assembled at the moulding station will have assumed the distribution pattern described above.

Mould halves used in the manufacture of lenses in accordance with the invention are produced by conventional procedures by injection moulding using master metal moulds at a moulding station. The mould halves are moulded from plastics material, normally polyolefins, e.g. polyethylene or polypropylene. Such plastics require some cooling and conditioning time before they can be filled with polymer, typically about 10 minutes. It is, therefore, convenient from this point of view to provide conveying and holding zones between the moulding station and the filling station, which require about 10 minutes for the moulds to transit. As explained above, this is also an appropriate time period for the loosely assembled mould halves to assume their desired orientation pattern.

At the filling station, each pallet is clamped as it enters the station, the male mould halves are lifted, without altering their relative orientation with the female mould halves. The latter are then filled with monomer and the male mould halves pressed into place, sealed and the monomer subjected to curing conditions.

The sorting of the lenses into groups of the same or similar rotational angle is preferably carried out while the lenses are still contained within the moulds in which they were cast. Although, theoretically, the lenses could be sorted prior to curing the monomer or other lens-forming composition, the sorting procedure is generally carried out after the lens-forming composition has been cured, but before the lenses are released from their moulds.

The invention is not limited to any particular method of sorting the lenses into groups having similar rotational angles. One available method is to remove the lenses from their moulds after curing (and optionally after swelling to final size in the case of hydrogel lenses), and then to directly measure the axes of each lens. Automated equipment exists which is capable of carrying out such measurements sequentially and at high speed.

However, there are advantages in effecting the sorting operation while the lenses are still contained in the moulds in which they were cast. Since the moulds protect the lenses very effectively, the lenses can be conveniently held in stock after sorting in a protected condition and further processed through washing, swelling, quality control and packing only when required.

Therefore, according to a further aspect of the invention there is provided apparatus for sorting cast moulded toric lenses into groups having the same or similar rotational angle while said lenses are contained in the moulds in which they were cast, said method comprising imaging marks on the respective mould halves, measuring the angle between the marks and sorting the lenses into groups, wherein each group has the same or similar rotational angle.

The marks may be formed respectively on rims of the male and female mould halves at the moulding step. By measuring the angle between lines passing through respective marks, the lenses can be sorted into lenses having the same or similar axis since the angle between the marks will bear a known relationship with the rotational angle and hence with the axis of the lens.

The above sorting method can be employed in other toric lens manufacturing processes in which lenses are formed by casting.

The invention will be illustrated by the following description and accompanying drawings, in which:

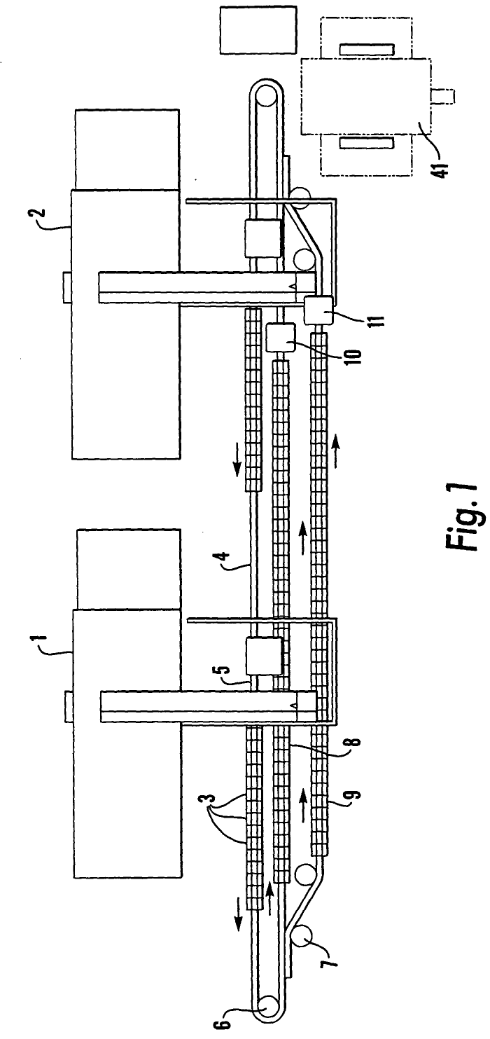

FIG. 1 is a plan view of the lens casting production line;

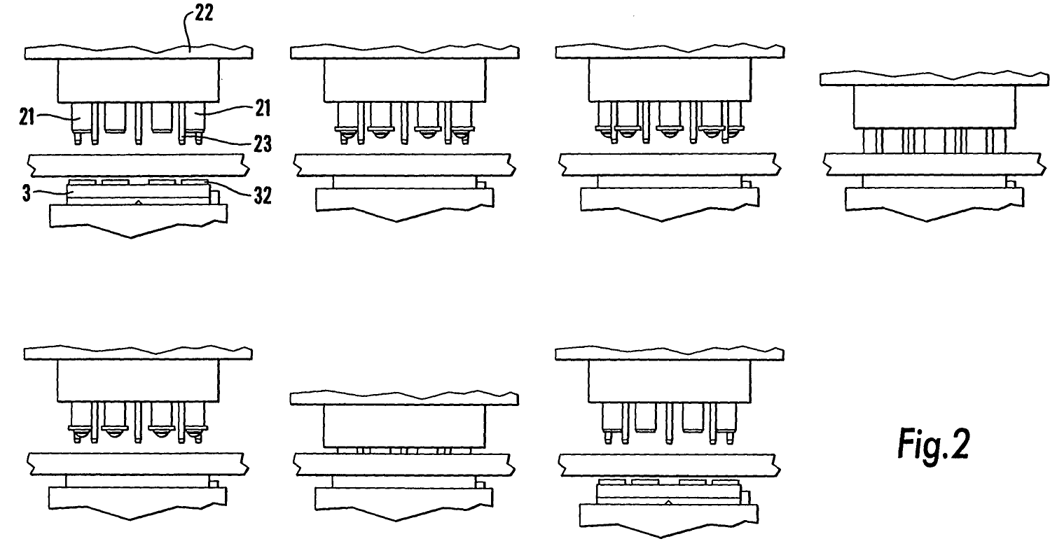

FIG. 2 is a series of views showing the mould filling step;

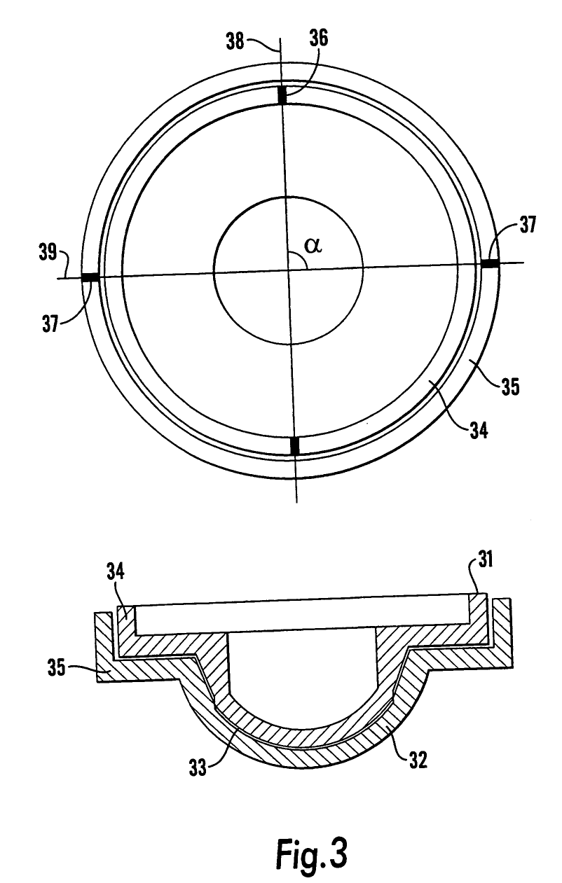

FIG. 3 shows views of the casting mould showing scribe lines of the mould halves;

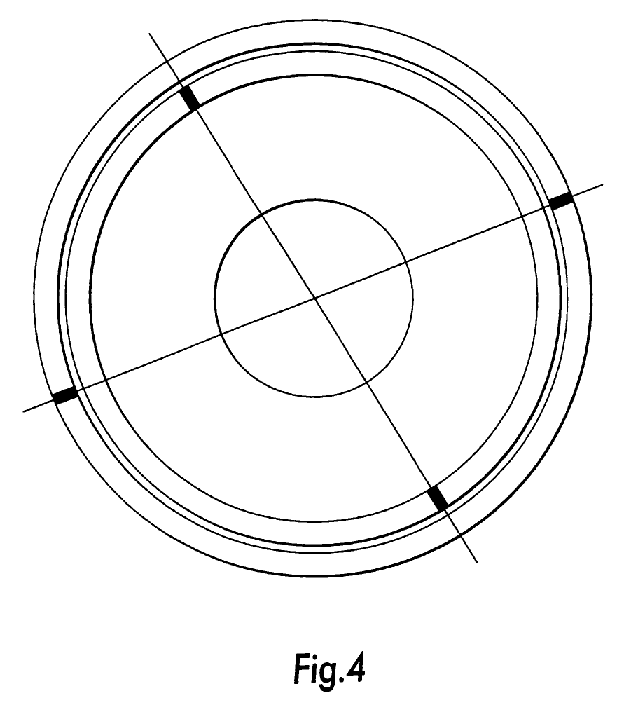

FIG. 4 is a view showing an image of an assembled mould;

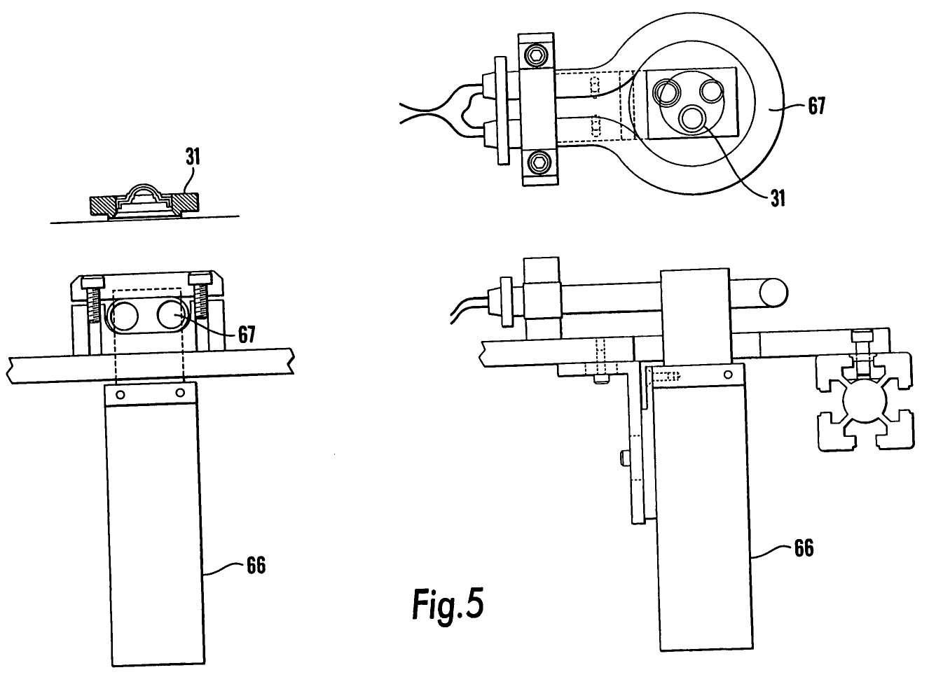

FIG. 5 shows an image-capturing system;

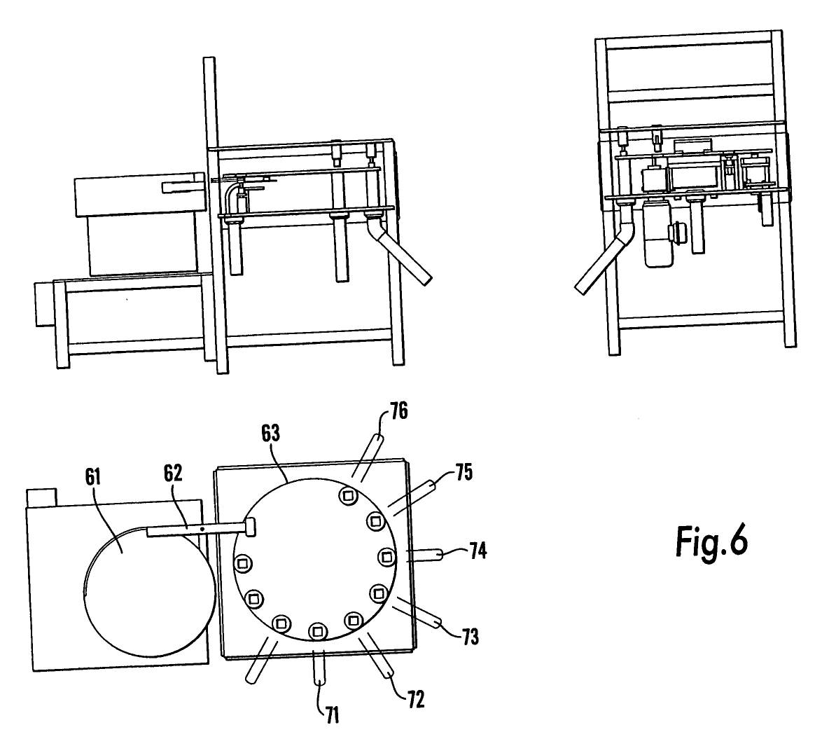

FIG. 6 shows various views of the lens-sorting apparatus; and

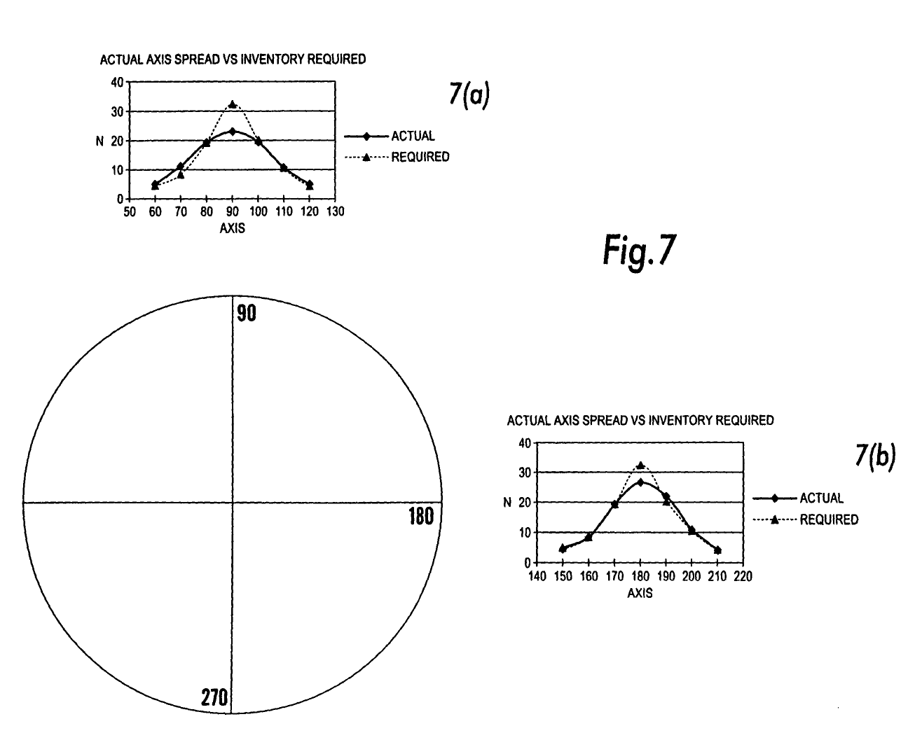

FIG. 7 shows typical results of manufacturing lenses in accordance with the invention.

Referring to the accompanying drawings, FIG. 1 shows a plan view of a lens manufacturing line comprising two injection moulding machines (1) and (2) for moulding respectively male and female thermoplastic mould halves. Moulding machine (2) manufactures the female mould halves and deposits these on a wheeled pallet (3) supported on a conveyor (4) moving in the direction of the arrow indicated in FIG. 2. Male mould halves manufactured by the injection moulding machine (1) are loosely assembled into the female mould halves at station (5) and the pallets (3) continue on the conveyor (4) in the direction of the arrow. After turning around the capstan (6) the conveyor continues to a switching station (7), at which point the pallets are switched between line (8) or (9) depending upon the number of pallets waiting in the queue for filling at parallel filling stations (10) and (11).

The conveyors are of conventional flat, flexible chain-link type which provides a substantial degree of mechanical agitation to the pallets as they are carried around curves and along the conveyors.

FIG. 3 shows a typical thermoplastic mould as produced by injection moulding machines (1) and (2).

Referring to FIG. 3, the upper view is a plan view and the lower view a section through the mould. As can be seen, the male mould half (31) forms with the female mould half (32) a lens-forming cavity (33). Generally, the male mould is shaped to provide the cylindrical axis on the lens, and the female mould moulds the power curve and the ballast, although the reverse is possible. The male mould includes a rim (34) which is wholly within an outer rim (35) of the female mould half. In order to determine the relative orientation of the male mould half with respect to the female mould half, markings such as scribe lines (36) are formed on the rim (34) of the male mould half and on the rim (35) of the female mould half. For ease of identification, markings on the rims of the two mould halves may be of a different character (37) (e.g. they may be lines of different thickness or a different length). Scribe lines are conveniently formed with laser marking equipment since these give a clear contrast with the background surface. The surface of the rims may be given a matt surface to provide better contrast, e.g. by providing an appropriate surface finish to the metal moulds from which the plastic moulds are formed by injection moulding. The orientation of the two lens moulding halves with respect to each other (and hence the rotational angle of the lens) is measured by determining the angle α between the imaginary line (38) passing through the scribe lines (36) and the corresponding line (39) passing through the scribe lines (37). This angle α may or may not be the same as the rotational angle of the lens but bears a known relationship with it and with the axis of the lens.

Normally, the mould halves are loosely assembled together at the station (5) in a position which corresponds with the rotational angle of the majority of the lenses which are intended to be manufactured in a particular batch. By the time the pallets (3) have reached the filling stations (10) or (11), the movement of the pallets on the conveyor and contact of the pallet with stops, clamps and release gates would have shaken the lens halves so that many of them differ from the orientation in which they have been loosely assembled at the station (5). An important part of the joggling of the mould halves takes place while the pallets are held at stops prior to loading at the filling stations. As can be seen in FIG. 1, a queue of pallets is held stationery in a line awaiting the enter the filling stations, while the flexible links of the conveyor continue to run beneath the pallets. Typically, the mould halves are produced in groups at the moulding stations and deposited onto pallets at about 10 second intervals. The length of the conveyor between the station at which mould halves are loosely assembled and the filling stations is preferably such that it takes about 10 to 15 minutes for a pallet carrying mould halves to reach the filling station.

At the filling station (see FIG. 2), the male moulds are lifted by means of the vacuum cup (21) on the index head (22). A measured amount of polymerisable lens-forming composition is then injected into the female mould half (32) via a monomer filler nozzle (23). The indexing head then lowers the male mould halves into the female mould halves, and are relocated into the female mould halves and pressed home. In this sequence, the orientation of the male moulds with their female mould halves remains the same.

After pressing home the male mould halves into the female mould halves, the pallet moves on to a curing station (41) as shown in FIG. 1. Curing station (41) may be an oven in which the lenses on their pallets are transported through the oven and remain there for a period long enough to effect polymerisation of the monomer composition.

The cured lenses in the cavities in which they have been moulded are then passed to the lens sorting apparatus.

The general layout of the lens sorting apparatus is shown in FIGS. 5 and 6. Essentially, the lenses, while still in the moulds in which they are cast are placed in a vibratory bowl feeder (61) from which they are fed through a loading chute (62) onto a rotary table (63). On the table (63) the moulds (31) are presented one after another in alignment with a camera (66) and are illuminated with a light (67). An image is formed of each of the lenses contained in their moulds in such a way that the scribe lines (38) and (39) can be visualised in the image. One example is shown in FIG. 4. The visualised image is transferred to a computer linked to the camera which has been programmed to measure the angle α between the alignment marks(36) and (37) on the male and female mould halves. This angle α is measured and the lens is sent to a receiving receptacle (71 to 75) which corresponds with the rotational angle of the lens within the mould. The computer may be programmed to sort lenses into groups which are, say, within 5° of a specified rotational angle. If a lens is beyond the permitted range which has been specified, or fails for some other reason, e.g. because of voids or bubbles within the lens, the lens within its container may be sent to a reject container (76).

Prior to carrying out a sorting operation on a batch of lenses, a sample of lenses is measured manually to establish that the angle a correctly represents the indicated rotational angle of the lens and to calibrate the lens sorting apparatus. By extending the manual measurement to a significant number of lenses, the calibration of the sorting apparatus is effectively equivalent to making the corresponding number of direct measurements on each lens. This leads to greater accuracy in assessing the lenses. The remaining lenses can then be sorted automatically, using the apparatus shown in FIG. 6. The sorting of the lenses is carried out automatically and controlled by a PC or PLC, thus involving minimal manual intervention. The computer programme includes a ‘teaching step’ in which the computer is inputted with information enabling the computer to establish the angle ‘alpha’ as indicated by the marks on the rims of the moulds which correctly represents the rotational angles of the lenses, obtained by manual measurement of a representative sample.

FIG. 7 represents typical results of the method of the present invention. As can be seen from the distribution curve (7a), the continuous line shows the distribution of rotational angles of lenses manufactured when the machine was set up, to loosely assemble mould halves at a rotational angle of 90°. In the lower left-hand distribution graph (7b), the result is shown of manufacturing lenses in which the machine was set up to assemble mould halves at a rotational angle of 180°. The dotted lines represent in each case the average spread of axis prescriptions of patients in the population, and it will be seen that the yield of lenses in accordance with the invention closely correspond with the required demand for toric lenses.

It will be appreciated that, e.g. by selecting settings at 45°, 90°, 135° and 180°, lenses can be manufactured by the method of the invention which covers all rotational angles required to provide a full inventory.

1. A method of cast moulding toric contact lenses in which each lens has a ballast and a toric central zone having a cylindrical axis, the cylindrical axis having an axis of orientation at a desired rotational angle with respect to the axis of the ballast, said method comprising the steps of:
providing sets of male and female mould halves (31, 32) wherein the surface of one mould half of each set defines said cylindrical axis and the surface of the other mould half of each set defines said ballast axis, introducing a flowable polymerisable composition into the female mould halves and closing the associated male mould halves fully into the female mould halves and curing the polymerisable composition to form toric contact lenses;
characterised by loosely assembling the sets of mould halves each in a relative position corresponding to the rotational angle of the majority of lenses to be moulded
transporting the loosely assembled sets of mould halves to a filling station (10, 11), where the flowable polymerisable composition is introduced to the female mould halves, under conditions in which the mould halves of each set are free to move relatively to each other in a rotational sense and the sets are subjected to a deliberate joggling action to ensure the mould halves of the sets assume relative orientations approximately corresponding to a guassion distribution curve during said transport or while being held prior to entry into the filling station and
sorting the lenses into groups of lenses having the same or similar rotational angles.

2. A method according to claim 1 in which the lenses are sorted by measuring angles (α) between marks (36, 37) on the associated mould halves which represent respectively the cylindrical axis and the horizontal meridian.

3. A method according to claim 1 wherein the lenses are sorted by forming images of marks (36, 37) on the respective mould halves, measuring the angle (α) between the marks (36, 37) and sorting the lenses into groups, wherein each group has the same or similar rotational angle.

4. A method according to claim 1, 2 or 3 wherein the resulting toric lenses are sorted while still in their moulds.

5. A method according to claim 2 or 3 in which the lenses are sorted after removal from their moulds.

6. Apparatus for carrying out the method of any one of claims 1 to 5: the apparatus comprising
machines (1, 2) for moulding respective sets of male and female halves (31, 32) wherein the surface of one mould half of each set defines the cylindrical axis of the subsequently cast lens and the surface of the other mould half defines the ballast axis of the subsequent cast lens
a filling station (10, 11) equipped to introduce a flowable polymerisable composition into the female mould halves and to close the associated male mould halves fully into the female mould halves and
a curing station (41) for curing the polymerisable composition to form toric contact lenses characterised in that
a station (5) is provided to pre-assemble the sets of mould halves loosely together each in a relative position corresponding to the rotational angle of the majority of lenses to be moulded
a transport system (3, 4, 7, 8, 9) composed of pallets and a flexible conveyor is provided for transporting the loosely assembled sets of mould halves from the assembly station (5) to the filling station (10, 11), the transport system serving to ensure the mould halves of each set are made to move relative to one another in a rotational sense and the sets are deliberately joggled to ensure the mould halves of the sets assume relative orientations approximately to a gaussion distribution curve during their transport from the assembly station to the filling station and means is provided for sorting the resulting lenses into groups having the same or similar rotational angles of the cylindrical axis with respect to the horizontal meridian.

7. A method for sorting cast-moulded toric lenses into groups having the same or similar rotational angle of the cylindrical axis with respect to the ballast axis while said lenses are contained in the moulds in which they were cast, said method comprising forming images of marks (36, 37) on the respective mould halves (31, 32), measuring the angle (α) between the marks (36, 37) and sorting the lenses into groups, wherein each group has the same or similar rotational angle.
